(19) United States
(12) Patent Application Publication
(10) Pub. No.: US 2004/0189921 A1
(43) Pub. Date: Sep. 30, 2004

(54) In plane switching liquid crystal display

(76) Inventors: Cheuh-Ju Chen, Miao-Li (TW); Jia-Pang Pang, Miao-Li (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/812,818

(22) Filed: Mar. 29, 2004

(30) Foreign Application Priority Data
Mar. 28, 2003 (TW) 92107183

(51) Int. Cl. G02F 1/1343

(52) U.S. Cl. 349/141

(57) ABSTRACT

An In Plane Switching liquid crystal display (2) includes a first substrate (22), a second substrate (21), a liquid crystal layer, a plurality of common electrodes (25) and pixel electrodes (26). The first substrate and the second substrate are disposed oppositely and spaced apart, and the liquid crystal layer is disposed therebetween. The common electrodes and the pixel electrodes are formed on the first substrate parallel. A plurality of conductive spacers (29) is formed on the common electrodes and the pixel electrodes. When a voltage is applied across the common electrode and the pixel electrode, an electric field substantially parallel to the first substrate and the second substrate is generated between the conductive spacers on the common electrode and the pixel electrode. The In Plane Switching liquid crystal display has a high aperture ratio and a low driving voltage.

### BACKGROUND OF THE INVENTION

1. Field of the Invention

The present invention relates to an In Plane Switching liquid crystal display (IPS-LCD), and especially to an IPS-LCD providing a high aperture ratio and a low driving voltage. The application relates to the contemporarily filed application titled “IPS LIQUID CRYSTAL DISPLAY WITH CONDUCTIVE SPACERS” and having two commonly inventors with the instant invention.

2. Description of Prior Art

In Plane Switching liquid crystal display (IPS-LCD) has been used in wide view angle display technology to improve a conventional twisted nematic liquid crystal display (TN-LCD). The IPS-LCD has common electrodes and pixel electrodes formed on a lower glass substrate and an in-plane electric field therebetween is generated to rearrange the LC molecules along the electrode field. Accordingly, the IPS-LCD can improve viewing angle, contrast ratio and prevent color shift over the conventional TN-LCD.

FIG. 5 is a cross-sectional view showing a conventional IPS-LCD 1 disclosed in U.S. Pat. No. 5,600,464. The IPS-LCD 1 includes a first substrate 11, a second substrate 12, a liquid crystal layer (not labeled), two polarizers 13, 14, an alignment film 100 and a plurality of common electrodes 15 and pixel electrodes 16. The liquid crystal layer is disposed between the first substrate 11 and the second substrate 12. The common electrodes 15 and pixel electrodes 16 are formed on the second substrate 12 at intervals paralleled with each other. The two polarizers 13, 14 are formed on two outsides of the first substrate 11 and the second substrate 12 respectively, whose polarization axes are perpendicular to each other. The alignment film 100 is formed on a side of the second substrate 12, facing the liquid crystal layer, for aligning liquid crystal molecules 17 along a predetermined direction of the liquid crystal layer. The alignment direction of the alignment film 100 is parallel to the polarization axe of the polarizer 14 and forms an angle from a line perpendicular to the common electrode 15 and pixel electrode 16. Thus, when no voltage is applied across the common electrode 15 and the pixel electrode 16, the IPS-LCD 1 displays black.

Referring to FIG. 6, when a voltage is applied across the common electrode 15 and the pixel electrode 16, there is an in-plane horizontal electric field 18 parallel to a surface of the second substrate 12, which between the common electrode 15 and the pixel electrode 16. The liquid crystal molecules 17 are twisted so as to align the long axes of the liquid crystal molecules 17 with the direction of the horizontal electric field 18, so that the IPS-LCD 1 displays white.

However, the intensity of the horizontal electric field 18 decreases with a vertical distance far from the common electrode 15 and the pixel electrode 16. That is the electric field intensity near the first substrate 11 is weaker than that near the second substrate 12. Thus a higher driving voltage is needed to make all the liquid crystal molecules 17 twisted. On the other hand, direction of the electric field 18 near the borders of the common electrode 15 and the pixel electrode 16 are not parallel to the surface of the second substrate 12. That is, not all long axes of the liquid crystal molecules 17 are aligned with the direction of the horizontal electric field 18. This results a low open aperture ratio.

It is desired to provide a In-Plane Switching liquid crystal display that solves the above-mentioned problems.

### SUMMARY OF THE INVENTION

An object of the present invention is to provide an In Plane Switching liquid crystal display (IPS-LCD), which has a high aperture ratio and a low driving voltage.

To achieve the above object, the IPS-LCD of the present invention includes a first substrate, a second substrate, a liquid crystal layer, a plurality of common electrodes and pixel electrodes. The first substrate and the second substrate are disposed oppositely and spaced apart, and the liquid crystal layer is disposed therebetween. The common electrodes and the pixel electrodes are formed on the first substrate parallel. A plurality of conductive spacers is formed on the common electrodes and the pixel electrodes. When a voltage is applied across the common electrode and the pixel electrode, an electric field substantially parallel to the first substrate and the second substrate is generated between the conductive spacers on the common electrode and the pixel electrode. The IPS-LCD has a high aperture ratio and a low driving voltage.

Other objects, advantages, and novel features of the present invention will become more apparent from the following detailed description when taken in conjunction with the accompanying drawings, in which:

### BRIEF DESCRIPTION OF THE DRAWINGS

FIG. 1 is an schematic diagram illustrating the off state operation mode of an IPS-LCD according to a preferred embodiment of the present invention;

FIG. 2 is a cross-sectional view of a conductive spacer of the IPS-LCD of FIG. 1;

FIG. 3 is an schematic diagram illustrating the on state operation mode of the IPS-LCD of FIG. 1;

FIG. 4 is an schematic diagram illustrating the on state operation mode of an IPS-LCD according to an alternative embodiment of the present invention; and

FIGS. 5-6 are schematic diagrams illustrating the operation of an conventional IPS-LCD.

### DETAILED DESCRIPTION OF THE INVENTION

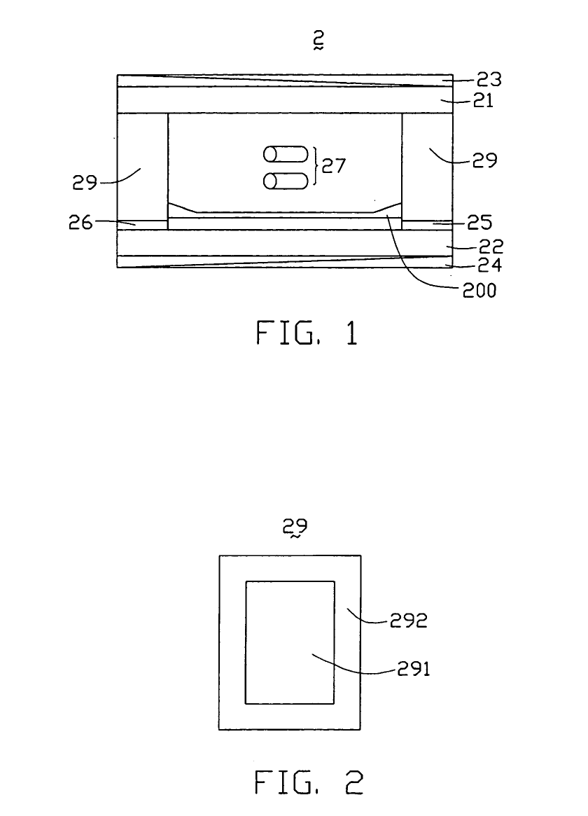

FIG. 1 shows an schematic diagram illustrating the off state operation mode of an In Plane Switching liquid crystal display (IPS-LCD) 2 according to a preferred embodiment of the present invention. The IPS-LCD 2 comprises a first substrate 21, a second substrate 22, and a liquid crystal layer (not labeled) having a plurality of liquid crystal molecules 27. The first substrate 21 and the second substrate 22 are spaced apart from each other, and the liquid crystal layer is disposed therebetween. The first substrate 21 and the second substrate 22 are made of glass. Alternatively, the first substrate 21 and the second substrate 22 also can be made of Silicon Dioxide (SiO₂).

Two polarizers 23, 24 are adhered to two sides of the first substrate 21 and the second substrate 22, respectively. An alignment film 200 is formed on a side of the second substrate 22, facing the liquid crystal layer. Alternatively, the alignment film 200 also can be formed on the first substrate 21. A plurality of common electrodes 25 and pixel electrodes 26 are formed on the second substrate 22, parallel to each other, and a plurality of conductive spacers 29 are formed thereon.

The polarization axes of the two polarizers 23, 24 are perpendicular to each other. The alignment film 200, whose alignment direction is parallel to the polarization axe of the polarizer 24, is used to align the liquid crystal molecules 27 of the liquid crystal layer. The common electrodes 25 and pixel electrodes 26, which are made of transparent conductive materials, such as indium tin oxide (ITO) and indium zinc oxide (IZO), are strip-shaped. The common electrodes 25 and the pixel electrodes 26 are disposed at same intervals. An insulating film (not labeled) is formed between the common electrodes 25 and the pixel electrodes 26 for insulating the common electrodes 25 and the pixel electrodes 26. The insulating film is made of SiO₂ or Silicon Nitride (SiNx).

Referring to FIG. 2, a cross-sectional view of the conductive spacer 29 is shown. The conductive spacer 29 comprises a spacer rib 291 and a conductive film 292. The spacer rib 291, which is made of glass, has a preferable shape of parallelepiped. The conductive film 292 made of transparent conductive materials, such as ITO, is deposited on all the surfaces of the spacer rib 291. So that the conductive spacers 29 are contacted with the common electrodes 25 and the pixel electrodes 26. The conductive spacers 29 are perpendicular to the common electrodes 25 and the pixel electrodes 26, then, spaces are formed between the conductive spacers 29. The height of the spacer 29 is substantially equal to the thickness of the liquid crystal layer. Thus, when a voltage is applied across the common electrodes 25 and the pixel electrodes 26, an electric field parallel to the second substrate 22, which distributes uniformly between the first substrate 21 and the second substrate 22 is generated. Alternatively, the spacer rib 291 is made of SiO₂ and the conductive film 292 is made of a metal.

FIG. 1 illustrates an off state operation mode for the IPS-LCD 2. When there is no voltage applied across the common electrodes 25 and the pixel electrodes 26, the alignment direction of the alignment film 200 forms an angle from a line perpendicular to the common electrodes 25 and pixel electrodes 26, the angle is 45 degrees, for example. Because the alignment direction of the alignment film 200 is parallel to the polarization direction of the polarizer 24, the long axes of the liquid crystal molecules 27 is parallel to the polarization direction of the polarizer 24. Light beams through the polarizer 24 pass the liquid crystal molecules 27 with no polarization state change. So that the light beams can't pass the polarizer 23 for the polarization state of the light beams perpendicular to that of the polarizer 23. Then the IPS-LCD 2 displays black.

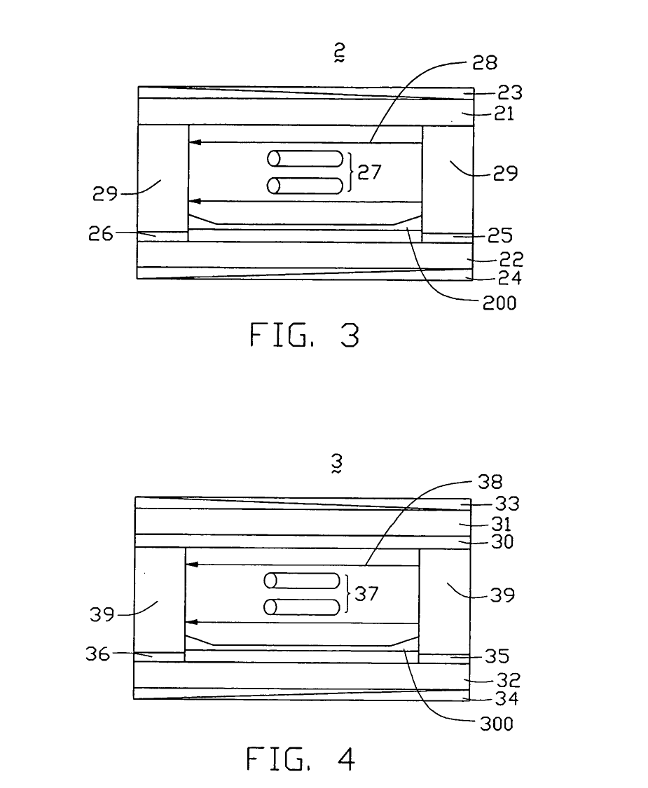

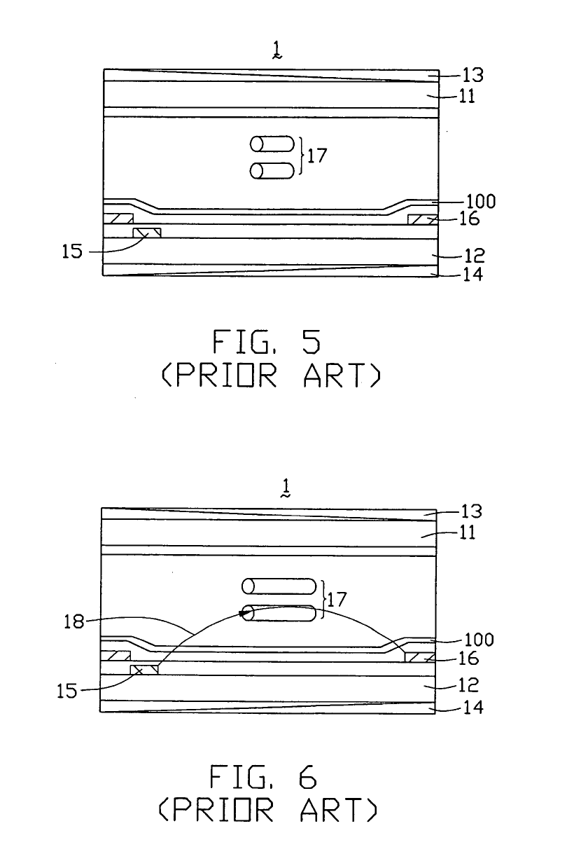

FIG. 3 illustrates an on state operation mode for the IPS-LCD 2. When a voltage is applied across the common electrodes 25 and the pixel electrodes 26, an electric field 28, which is parallel to the surface of the second surface 22, is generated between the two adjacent spacers 29 formed on the common electrodes 25 and the pixel electrodes 26, respectively. Then, the liquid crystal molecules 27 are twisted such that the long axes thereof coincide with the electric field direction. Thereby, the liquid crystal molecules 27 are aligned such that the long axes thereof are perpendicular to the common electrodes 25 and the pixel electrodes 26. When the light beams pass through the liquid crystal layer, the polarization state of the light beams is changed to match with that of the polarizer 23. Thus the light beams can pass through the polarizer 23 and the IPS-LCD 2 displays white.

FIG. 4 shows an alternative embodiment of an IPS-LCD of the present invention. The IPS-LCD 3 comprises a first substrate 31, a second substrate 32, and a liquid crystal layer (not labeled) having a plurality of liquid crystal molecules 37. The first substrate 31 and the second substrate 32 are spaced apart from each other, and the liquid crystal layer is disposed therebetween.

Two polarizers 33, 34 are adhered to sides of the first substrate 31 and the second substrate 32, respectively. A color filter 30 is formed on an inner surface (not labeled) of the first substrate 31 for realizing a color display. An alignment film 300 is formed on a side of the second substrate 32, facing the liquid crystal layer, for aligning the liquid crystal molecules 37. A plurality of common electrodes 35 and pixel electrodes 36 are formed on the second substrate 32 parallel to each other, and a plurality of conductive spacers 39 are formed thereon.

In summary, the IPS-LCD 2, 3 according to the present invention have the following main advantages. First, the conductive spacers 29, 39 are formed on the common electrodes 25, 35 and the pixel electrodes 26, 36, so that the electric field 28, 38 distribute uniformly between the first substrate 21, 31 and the second substrate 22, 32. Thus, all the liquid crystal molecules 27, 37 are twisted by the electric field 28, 38 without increasing the driving voltage. Second, the electric field 28, 38 are substantially parallel to the second substrate 22, 23 even in regions near the common electrodes 25, 35 and the pixel electrodes 26, 36. So that the long axes of all the liquid crystal molecules 27, 37 are aligned with the direction of the electric field 28, 38. This can enhance the aperture ratio of the IPS-LCD 2, 3.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. An In Plane Switching liquid crystal display comprising:
a first substrate, and a second substrate disposed oppositely and spaced apart from a predetermined distance;
a liquid crystal layer interposed between the first substrate and the second substrate;
a plurality of common electrodes and pixel electrodes formed on the first substrate, parallel to each other; and
a plurality of conductive spacers formed on the common electrodes and the pixel electrodes.

2. The In Plane Switching liquid crystal display as claimed in claim 1, wherein each of the spacers comprises a spacer rib and a conductive film.

3. The In Plane Switching liquid crystal display as claimed in claim 2, wherein the spacer rib has a form of parallelepiped.

4. The In Plane Switching liquid crystal display as claimed in claim 2, wherein the conductive film covers the whole surface of the spacer ribs.

5. The In Plane Switching liquid crystal display as claimed in claim 2, wherein the spacer rib is made of glass.

6. The In Plane Switching liquid crystal display as claimed in claim 2, wherein the spacer rib is made of SiO₂.

7. The In Plane Switching liquid crystal display as claimed in claim 2, wherein the conductive film is made of ITO.

8. The In Plane Switching liquid crystal display as claimed in claim 2, wherein the conductive film is made of conductive metal.

9. The In Plane Switching liquid crystal display as claimed in claim 1, wherein the common electrodes and pixel electrodes are made of ITO.

10. The In Plane Switching liquid crystal display as claimed in claim 1, wherein the first substrate and the second substrate are made of one of glass and SiO₂.

11. The In Plane Switching liquid crystal display as claimed in claim 1, further comprises an insulating film disposed between the common electrode and the pixel electrode.

12. The In Plane Switching liquid crystal display as claimed in claim 11, wherein the insulating film is made of one of SiO₂ and SiNx.

13. The In Plane Switching liquid crystal display as claimed in claim 1, further comprises two polarizers formed on two sides of the first substrate and the second substrate, respectively.

14. The In Plane Switching liquid crystal display as claimed in claim 1, further comprises an alignment film formed on one of the first substrate and the second substrate.

15. The In Plane Switching liquid crystal display as claimed in claim 1, further comprises a color filter formed on an inner surface of the second substrate facing to the liquid crystal layer.

16. An In Plane Switching liquid crystal display comprising:
a first substrate, and a second substrate disposed oppositely and spaced apart from a predetermined distance;
a liquid crystal layer interposed between the first substrate and the second substrate;
a plurality of common electrodes and pixel electrodes formed on the first substrate, parallel to each other; and
a plurality of spacers formed on the common electrodes and the pixel electrodes and directly contacting the second substrate so that crystals of said liquid crystal layer are substantially fully enclosed among the first substrate, the second substrate, the common electrodes and the pixel electrodes and the spacers in a vertical cross-sectional viewpoint.

17. An In Plane Switching liquid crystal display comprising:
a first substrate, and a second substrate disposed oppositely and spaced apart from a predetermined distance;
a liquid crystal layer interposed between the first substrate and the second substrate;
a plurality of common electrodes and pixel electrodes formed on the first substrate, parallel to each other; and
a plurality of spacers formed on the common electrodes and the pixel electrodes and directly contacting the second substrate; wherein
an alignment film is horizontally located among the spacers.
